(19) United States
(12) Patent Application Publication
(10) Pub. No.: US 2012/0023685 A1
(43) Pub. Date: Feb. 2, 2012

(54) Fabric Dyeing Apparatus and Method

(76) Inventors: Michael Kevin Sell, Walkertown, NC (US); Larry Harris, King, NC (US)

(21) Appl. No.: 12/848,588

(22) Filed: Aug. 2, 2010

(51) Int. Cl. C09B 62/00; D06F 33/00; C09B 67/22

(52) U.S. Cl. 8/527; 8/543; 68/12.07

(57) ABSTRACT

A fabric dyeing apparatus and/or method can include a tunnel, such as a modified bleaching tunnel, comprising a plurality of chambers through which a load of fabric is successively transferred. A first set of the chambers can include a consecutive series of dye chambers through which the fabric load and a single dye bath are successively transferred and in which the dye bath is heated to about the same temperature in each of the dye chambers. A first chamber in the series of dye chambers and each chamber subsequent to the dye chambers can be adapted to receive a fresh water bath. A last chamber in the series of dye chambers and each subsequent chamber can be adapted to drain the bath in those chambers. The weight ratio of dye bath mixture-to-fabric can be about 5:1. The dye bath can include a fiber reactive dye or a direct fabric dye.

### FIELD OF THE INVENTION

The present invention relates to a fabric dyeing apparatus and method. Such an apparatus and/or method may be useful for saving time, materials, and cost related to dyeing fabric.

### BACKGROUND OF THE INVENTION

Conventional commercial fabric dyeing processes can have certain economic, quality control, environmental, and other disadvantages. For example, the ratio of dye bath mixture-to-fabric in a conventional fabric dyeing process can be about 10:1, resulting in a high cost for water and chemical additives in the dye bath mixture. Another disadvantage is that, although “reactive dyeing” processes may provide greater color fastness and quality control, “direct dyeing” processes can be less expensive and are thus often used to dye fabric, resulting in lower quality products. When conventional “reactive dyeing” processes are employed to dye fabric in a commercial setting, processing time can be six hours or longer, which decreases productivity. Another disadvantage is that a fabric dyeing apparatus is often configured to include separate compartments for processing a load of fabric from one step to another, which can require separately heating each chamber for different processing steps, thereby increasing processing costs.

In addition, expensive conventional fabric bleaching tunnels may sit idle while the need for dyeing large loads of fabric exists. Therefore, potential resources for dyeing fabric can go unused.

Thus, there is a need for a fabric dyeing apparatus and/or method having a lower ratio of dye bath mixture-to-fabric than required in a conventional fabric dyeing process so as to decrease the cost of water in the dye bath mixture. There is a need for such an apparatus and/or method that utilizes “reactive dyeing” processes in order to provide greater color fastness and quality control. There is a need for such an apparatus and/or method that utilizes “reactive dyeing” processes having a processing time substantially less than six hours as employed in conventional fabric dyeing processes. There is a need for such an apparatus and/or method that utilizes a conventional bleaching tunnel converted to accommodate fabric dyeing.

### SUMMARY

Some embodiments of the present invention can include a fabric dyeing apparatus and/or method. In some embodiments, a fabric dyeing apparatus can include a tunnel comprising a plurality of chambers through which a load of fabric is successively transferred. A first set of the plurality of chambers can comprise a consecutive series of dye chambers through which the fabric load and a single dye bath are successively transferred, in which the dye bath is heated to about the same temperature in each of the dye chambers, and in which the fabric load is exposed to the dye bath for about 35 minutes to about 60 minutes. A first chamber in the series of dye chambers and each chamber subsequent to the dye chambers can be adapted to receive a fresh water bath. A last chamber in the series of dye chambers and each subsequent chamber can be adapted to drain the bath in those chambers.

In some embodiments of the fabric dyeing apparatus, the weight ratio of dye bath mixture-to-fabric can be about 5:1. In some embodiments, the dye bath can comprise a fiber reactive dye or a direct fiber dye. Such an apparatus can be utilized to effectively dye a fabric comprising cotton or a cotton blend.

In some embodiments, the tunnel comprising the fabric dyeing apparatus can be a modified bleaching tunnel. For example, the fabric dyeing apparatus can comprise a 15-chamber bleaching tunnel. Such a bleaching tunnel can be adapted to bleach the fabric load in one cycle through the plurality of chambers and dye the fabric load in another cycle through the plurality of chambers.

The present invention can include embodiments of a method of dyeing a fabric and/or fabric product. Such a method of dyeing a fabric can utilize all or portions of the fabric dyeing apparatus described herein. For example, in some embodiments, a fabric bleaching tunnel comprising a plurality of chambers can be modified to receive a dye bath in a first set of selected chambers and to drain the bath in a second set of selected chambers such that a load of fabric can be successively transferred through the plurality of chambers. In this way, the bleaching tunnel is capable of dyeing fabric.

In some embodiments of the fabric dyeing method, the weight ratio of dye bath mixture-to-fabric can be about 5:1. In certain embodiments, the fabric load can be processed through the apparatus in about two hours. Such methods can further include bleaching the fabric load in one cycle through the plurality of chambers and dyeing the fabric load in another cycle through the plurality of chambers.

Features of a fabric dyeing apparatus and/or method may be accomplished singularly, or in combination, in one or more of the embodiments of the present invention. As will be realized by those of skill in the art, many different embodiments of a fabric dyeing apparatus and/or method are possible. Additional uses, advantages, and features of aspects of the present invention are set forth in the illustrative embodiments discussed in the detailed description herein and will become more apparent to those skilled in the art upon examination of the following.

### BRIEF DESCRIPTION OF THE DRAWINGS

FIG. 1 is a diagrammatic illustration of a fabric dyeing apparatus in an embodiment of the present invention.

FIG. 2 is a chart identifying the additives, temperature, and cycle time in each of the chambers of the fabric dyeing apparatus shown in FIG. 1, for dyeing fabric in an embodiment of a reactive dyeing process of the present invention.

FIG. 3 is a chart identifying the additives, temperature, and cycle time in each of the chambers of the fabric dyeing apparatus shown in FIG. 1, for dyeing fabric in an embodiment of a direct fabric dyeing process of the present invention.

### DETAILED DESCRIPTION

For the purposes of this specification, unless otherwise indicated, all numbers expressing quantities, conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein.

As used in herein, the singular forms “a,” “an,” and “the” include plural referents unless the context clearly dictates otherwise. Thus, for example, the term “a dye bath” is intended to mean a single dye bath or a combination of dye baths.

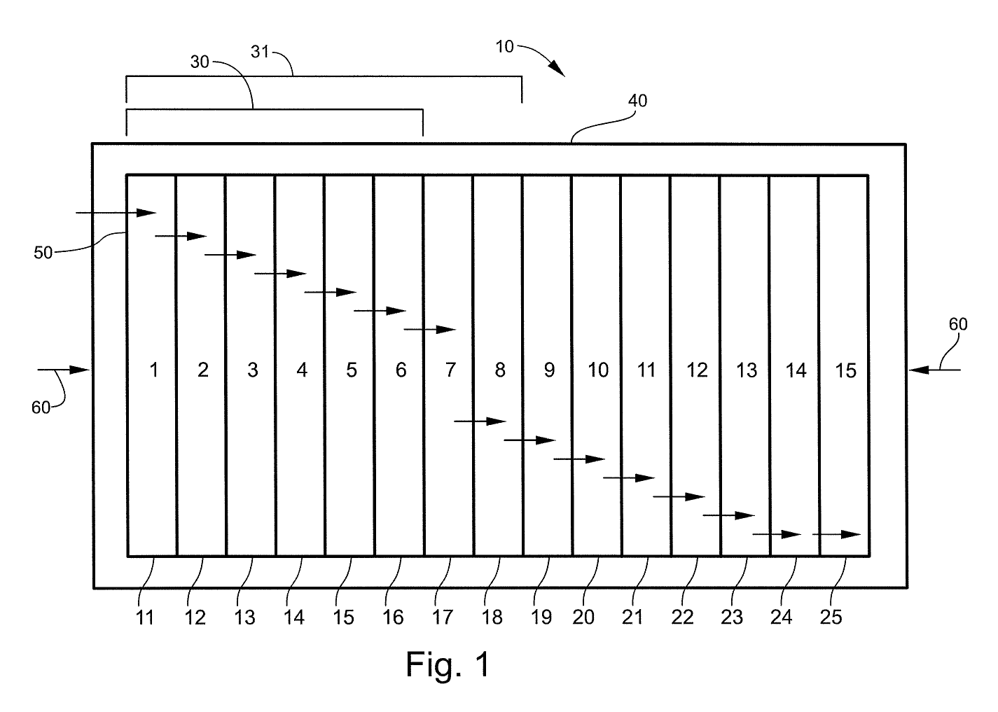

As used herein, the term “fabric” means fabric and/or fabric product. For example, “fabric” can refer to a piece of textile material that has not been made into a product and/or to a fabric product, such as a sock, comprising a piece of textile material. Some embodiments of the present invention can provide a fabric dyeing apparatus and/or method. FIGS. 1-3 illustrate various aspects of embodiments of such a fabric dyeing apparatus and/or method.

Some embodiments of the fabric dyeing apparatus 10 can include a plurality of discrete chambers (11-25) for processing fabric through different steps in a process for dyeing fabric. FIG. 1 shows a diagrammatic embodiment of the fabric dyeing apparatus 10 having 15 chambers.

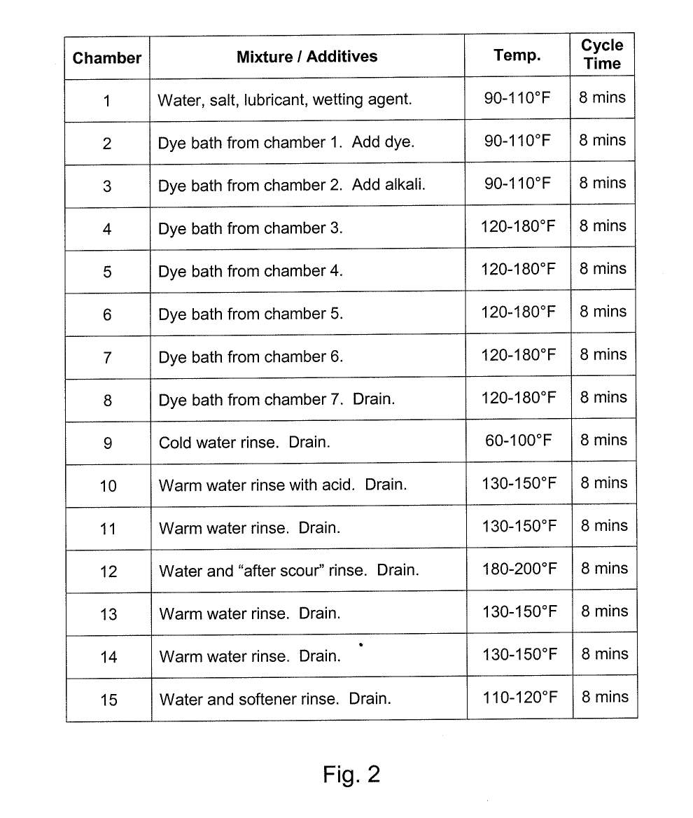

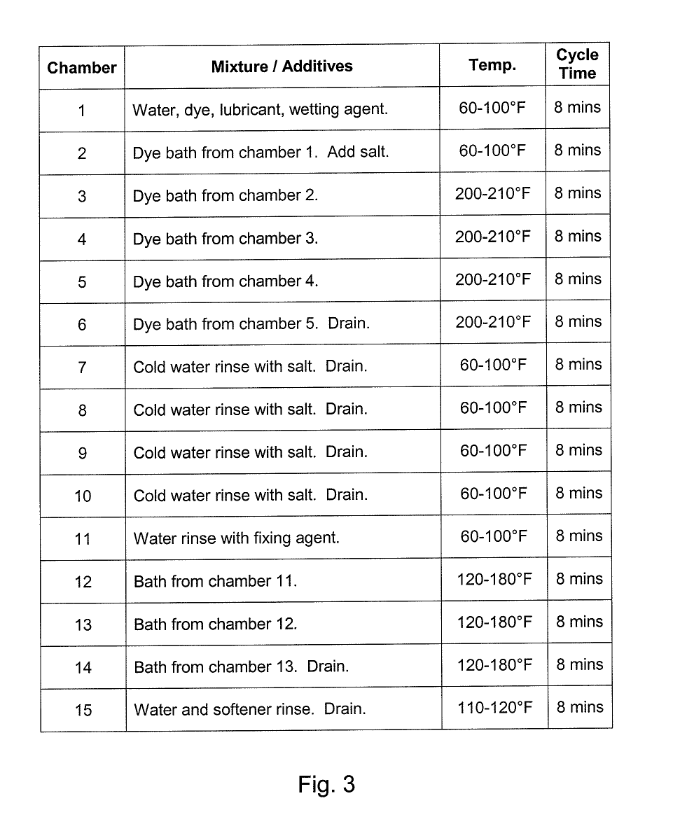

In an exemplary embodiment of a fabric dyeing apparatus 10, the apparatus 10 can include a tunnel comprising a plurality of chambers (11-25) through which a load of fabric is successively transferred. A first set of the plurality of chambers (11-25) can comprise a consecutive series of dye chambers 30 (chambers 11-16, as shown in FIG. 3) or dye chambers 31 (chambers 12-18, as shown in FIG. 2) through which the fabric load and a single dye bath are successively transferred, in which the dye bath is heated to about the same temperature in each of the dye chambers 30, 31, and in which the fabric load is exposed to the dye bath for about 35 minutes to about 60 minutes. The first chamber 11 or 12 in the series of dye chambers 30 or 31, respectively, and each chamber (17-25, as shown in FIG. 3, or 19-25, as shown in FIG. 2) subsequent to the dye chambers 30, 31 can be adapted to receive a fresh water bath. A last chamber 16 or 18 in the series of dye chambers 30 or 31, respectively, and each subsequent chamber (17-25 or 19-25) can be adapted to drain the bath in those chambers (17-25 or 19-25).

In some embodiments, the tunnel comprising the fabric dyeing apparatus 10 can be a modified bleaching tunnel. Some embodiments of the fabric dyeing apparatus 10 can include 15 chambers, for example, an embodiment that is converted from a conventional 15-chamber bleaching tunnel. That is, a fabric bleaching tunnel comprising a plurality of chambers 11-25 can be converted into a dyeing apparatus capable of dyeing fabric. For example, a bleaching tunnel in which a load of fabric can be successively transferred through the plurality of chambers 11-25 can be modified to receive a dye bath in a first set of selected chambers 30, 31, and to drain the bath in a second set of selected chambers 17-25 or 19-25, respectively.

A conventional fabric bleaching tunnel that can be converted, or adapted, for use as an embodiment of the fabric dyeing apparatus 10 is the Power Trans PT 50-15 Beaching Tunnel commercially available from Kannegiesser-USA located in Grand Prarie, Tex. A bleaching tunnel comprising a high quality stainless steel, such as at least a 316 gauge stainless steel, is preferable for conversion to the fabric dyeing apparatus 10 because such higher grade stainless steel can better withstand the corrosive effect of salt utilized in certain chambers in some fabric dyeing processes.

One cost savings realized by the fabric dyeing apparatus 10 and/or methods relates to the reuse of the same heated dye bath in the set of dye chambers 30 (chambers 11-16, as shown in FIG. 3) or dye chambers 31 (chambers 12-18, as shown in FIG. 2). Since each of the set of dye chambers 30, 31 is heated to the same temperature, and the load of fabric or fabric product and the same dye bath are transferred through each of the set of dye chambers 30, 31, the amount of energy required to heat each chamber after the initial chamber in the dye chambers 30, 31 is reduced. In addition, due to the use of preheated fabric or fabric product and dye bath in each chamber after the initial chamber in the dye chambers 30, 31, the amount of time needed to heat those chambers to the desired temperature after the load and dye bath are added is also reduced.

In some embodiments, a fresh water bath can be introduced in each of the chambers (19-25) following the initial dye chambers 30 comprising the dye bath, as in FIG. 2. In other embodiments, a fresh water bath can be introduced in each of the chambers (17-25) following the initial dye chambers 31 comprising the dye bath, as in FIG. 3. A fresh water bath provides a rinse for the fabric or fabric product to remove excess dye, acid, after scour, softener, or other bath mixture ingredients, depending on the chamber in which the water rinse is introduced.

In some embodiments of the fabric dyeing apparatus 10 (modified from a conventional bleaching tunnel), one or more of the chambers (11-25) can be configured as circular drums and can rotate about a central axis 60. In certain embodiments, one or more of the chambers (11-25) can rotate in complete revolutions, or spin, about the central axis 60 so as to tumble or agitate the load and enhance exposure of the load to the bath in that chamber (11-25). In addition, or alternatively, one or more of the chambers (11-25) can rotate from side to side about the central axis 60 so as to provide agitation. In some embodiments of the fabric dyeing apparatus 10, each of the chambers (11-25) can rotate about the central axis 60.

Some embodiments of the fabric dyeing apparatus 10 (modified from a conventional bleaching tunnel), can comprise a horizontally disposed drum structure having an open inlet end into which textile goods to be bleached or dyed may be inserted, and an open outlet end through which bleached or dyed textile goods may be discharged. The drum structure can be that of a tunnel type, continuous batch washer. The drum structure can have a stationary cylindrical outer wall 40 and a perforated cylindrical inner chamber 50 concentrically disposed within the outer wall 40. The inner chamber 50 can be drivable relative to the outer wall 40, for example, such that the inner chamber 50 is alternately rocked back and forth, or oscillated, through a rotational arc of less than 360 degrees, for example, approximately 240 degrees, and/or rotated through a full 360 degree arc. The interior of the outer wall 40 can be axially divided into a prescour zone positioned at the inlet end and bleach and rinse zones positioned downstream of the prescour zone. Each of the zones can comprise one or more chambers (11-25) in embodiments of the fabric dyeing and/or bleaching apparatus 10. Likewise, the interior of the inner chamber 50 can be divided into axial sections received within the prescour, bleach, and rinse zones of the outer wall 40. By rotating at least partially through an arc, the inner chamber 50 can operate to axially shift textile goods through successive sections of the drum structure toward the open outlet end, and then outwardly through the open outlet end. In alternative embodiments, the fabric dyeing apparatus 10 can comprise the horizontally disposed drum structure comprising chambers (11-25) without the outer wall 40.

The fabric dyeing apparatus 10 can further include a drive means for operatively driving the inner chamber 50 relative to the outer wall 40. The fabric dyeing apparatus 10 can further include a heating means for heating water disposed in the various chambers (11-25) or zones, for example, by injecting steam into the respective chambers (11-25) or zones. The fabric dyeing apparatus 10 can further include a means for selectively adding dyeing process components, bleaching components, and/or other bath components to the various chambers (11-25) or zones. The fabric dyeing apparatus 10 can further include circulation means for providing water in the various chambers (11-25) or zones in a manner so as to maintain essentially constant, equal heights of water in lower side portions of each of the chambers (11-25) or zones and in the sections of the inner chamber 50 disposed therein.

Thus, in some embodiments of the fabric dyeing apparatus 10, such a tunnel can comprise a horizontally disposed drum structure, in which the plurality of chambers (11-25) is disposed along the central axis 60 between an inlet end into which the fabric load can be inserted and an outlet end through which the fabric load can be discharged. Each of the plurality of chambers (11-25) may be movable at least partially about the axis 60 of the drum structure.

Embodiments of the fabric dyeing apparatus 10 preferably include 15 chambers, as shown in FIG. 1. Alternatively, some embodiments of the fabric dyeing apparatus 10 can include a different number of chambers. For example, some embodiments can include 12 or 13 discrete chambers for processing fabric through different steps in a dyeing process. Such embodiments can be converted from a conventional 12- or 13-chamber bleaching tunnel. In a 12- or 13-chamber fabric dyeing apparatus modified from a bleaching tunnel, the same sequence of baths can be provided as in the 15-chamber fabric dyeing apparatus 10, and the cycle time(s) can be adjusted to accomplish optimal exposure to each type of bath, such as a dye bath, acid bath, after scour bath, and softener bath for a reactive dyeing process, or a dye bath, fixing agent bath, and softener bath for a direct fabric dyeing process.

In another alternative embodiment, the fabric dyeing apparatus 10 can include as few as four chambers useful for a reactive fabric dyeing process. In such a four-chamber apparatus, the first chamber can comprise a dye and alkali bath, the second chamber an acid rinse, the third chamber an “after scour” rinse, and the fourth chamber a softener rinse. In yet another alternative embodiment, the fabric dyeing apparatus 10 can include as few as three chambers useful for a direct fabric dyeing process. In such a three-chamber apparatus, the first chamber can comprise a dye and salt bath, the second chamber a bath having a fixing agent, and the third chamber a softener rinse.

In some embodiments, a conventional bleaching tunnel as described herein can be modified so as to accommodate both bleaching and dyeing a load of fabric or fabric product. For example, such a bleaching tunnel can be adapted to bleach the fabric load in one cycle through the plurality of chambers (11-25) and/or dye the fabric load in another cycle through the plurality of chambers (11-25).

Such a conventional bleaching tunnel can include as part of its original design, or it can be modified to include, components of an embodiment of the fabric dyeing apparatus 10 as desired. For example, a conventional bleaching tunnel can include as part of its original design, or it can be modified to include, a drain mechanism in particular chambers, such as the eighth through fifteenth chambers (18-25, as shown in FIG. 2) or the sixth through eleventh and fifteenth chambers (16-21 and 25, as shown in FIG. 3), so as to allow draining those chambers as desired in a fabric dyeing process. In addition, or alternatively, such a conventional bleaching tunnel can be modified to include in selected chambers other components of an embodiment of the fabric dyeing apparatus 10 that are not included in the original design of the bleaching tunnel, such water inlet valve(s) and/or one or more inlet ports for dye, salt, wetter, lubricant, acid, after scour, softener, and/or other bath ingredients. In this way, the modified bleaching tunnel can comprise an embodiment of the fabric dyeing apparatus 10 and be utilized for both bleaching and for dyeing fabric and/or fabric products.

As an example of a bleaching tunnel than can be utilized for both bleaching and for dyeing a load of fabric or fabric product, the apparatus 10 can be configured for bleaching as follows: chambers 11 and 12 for scouring fabric; chamber 13 for draining and then adding bleaching chemicals; chambers 13-19 for bleaching; chamber 20 for draining; chambers 21-24 for rinsing; and chamber 25 for adding a softener. The same apparatus 10 can be configured for dyeing a load of fabric or fabric product as follows: chambers 11-12 for adding a dye bath; chamber 13 for adding alkali; chambers 14-18 for transferring the load and dye bath from chamber 13 through each of these chambers 14-18; chamber 18 for draining the bath; chamber 19 for a water rinse and draining; chamber 20 for a water rinse with acid and draining; chamber 21 for a water rinse and draining; chamber 22 for adding a water and after scour rinse and draining; chambers 23-24 for adding a water rinse and draining; and chambers 25 for adding a water rinse and softener and draining. In such an example of a modified bleaching tunnel, fabric or fabric product can be bleached in one cycle through the 15 chambers (11-25) of the apparatus 10 and dyed through a different cycle through the 15 chambers (11-25).

In a conventional fabric dyeing process, about one part fabric or fabric product is typically placed in about 10 parts of a dye bath mixture, for a weight ratio of dye bath mixture-to-fabric or fabric product of about 10:1. In some embodiments of the fabric dyeing apparatus 10 and/or methods of the present invention, about one part fabric or fabric product can be effectively processed in about five parts of a dye bath mixture, for a weight ratio of dye bath mixture-to-fabric or fabric product of about 5:1. As an example, for a load comprising approximately 100 lbs. of fabric or fabric product in the chambers (11-25) in the fabric dyeing apparatus 10, about 500 lbs. of water and dye bath mixture components can be utilized in the dye bath. Accordingly, the ratio of dye bath mixture-to-fabric or fabric product in some embodiments of the present invention can be substantially less than the ratio of dye bath mixture-to-fabric or fabric product in a conventional fabric dyeing process. Thus, about twice as much fabric or fabric product can be dyed in embodiments of the present invention in the same amount of water as can be dyed in conventional dyeing processes. As a result, some embodiments of the fabric dyeing apparatus 10 and/or methods can provide a cost savings compared to a conventional fabric dyeing process.

Embodiments of the fabric dyeing apparatus 10 can be utilized to effectively dye a fabric comprising cotton or a cotton blend. However, the fabric dyeing apparatus 10 can be utilized to dye fabric comprising other natural or synthetic fibers or combinations thereof.

The present invention includes embodiments of a method for dyeing fabric. One such embodiment includes modifying a fabric bleaching tunnel comprising the plurality of chambers (11-25) to receive a dye bath in a first set of selected chambers 30, 31 and to drain the bath in a second set of selected chambers (of chambers 11-25) such that a load of fabric can be successively transferred through the plurality of chambers (11-25). In this way, the bleaching tunnel is capable of dyeing fabric. In a bleaching tunnel modified as such, a fabric load can be bleached in one cycle through the plurality of chambers (11-25), and the fabric load can be dyed in another cycle through the plurality of chambers (11-25).

In some embodiments, such a method can further include transferring the fabric load into the dye bath at a weight ratio of the dye bath-to-fabric of about a 5:1, as described herein in relation to the fabric dyeing apparatus 10.

Fabric and fabric products can be dyed in various ways, including “reactive dyeing” and “direct dyeing.” Accordingly, in some embodiments of the present invention, fabric can be dyed with a fiber reactive dye. In other embodiments, fabric can be dyed with a direct fiber dye.

Fiber reactive dyes are often used to dye cotton, cellulose, and blends thereof. These dyes can also be used to dye acrylics, nylon, silk, and wool, and blends of these fibers. Fiber reactive dyes are easy to apply and produce brilliant shades, fastness, penetration, and leveling. Fiber reactive dyes are anionic in nature and react chemically with the fiber. The dyes include a chromophore to give color to the dye and a reactive group to form a chemical bond with the fiber. There may also be a substitutent or solubilizing group which provides additional dyeing characteristics such as solubility, substantivity, migration, washing off, etc. Fiber reactive dyes react in the presence of alkali to form a strong covalent chemical bond between a carbon atom of the dye molecule and an oxygen atom of the hydroxyl group in the cellulose. In this way, reactive dyeing can produce a high level of color fastness in the dyed fabric.

“Direct dyeing” involves attraction of dye to fabric fibers, such as cotton, by van der Waals forces, which includes electrostatic, polar, and other forces of attraction between molecules. As such, direct dyeing can be less predictable than reactive dyeing due to, for example, possible inconsistencies in dye attraction to the fabric, which may not be visualized until the dyeing process is completed. However, in conventional fabric dyeing processes, due to the length of processing time required, and possibly due to the amount of dye utilized, reactive dyeing may be more expensive than direct dyeing. Thus, in order to control cost, direct dyeing is often utilized in such conventional fabric dyeing processes, for example, with products in which color fastness may not be a top priority.

In addition, although reactive dyeing may provide certain advantages, some conventional dyeing processes for fabric can require six or more hours of processing time. In contrast, fabric or fabric products can be fully processed in the fabric dyeing apparatus 10 and/or methods of the present invention in about two (2) hours. For example, a load of about 105 lbs. of fabric or fabric products can be cycled through one of the 15 chambers of the apparatus 10 about every eight (8) minutes, as illustrated in FIGS. 2 and 3. A new 105 lb. load of fabric or fabric products can be loaded into the first chamber 11 every eight minutes (following transfer of the existing load from the first chamber 11 to the second chamber 12). That is, the first 105 lb. batch, or load, of fabric or fabric products can be dyed in about two hours, followed by another load about every eight minutes. As a result, in about six hours, 42 loads (about 4,410 lbs.) of fabric or fabric products can be dyed utilizing the fabric dyeing apparatus 10 and/or methods of the present invention. In contrast, only about 350 lbs. of fabric or fabric products can be processed in a conventional dyeing process in the same amount of time. Thus, some embodiments of the present invention can provide an increased volume of dyed fabric and/or fabric products in a substantially reduced processing time, as compared to conventional dyeing processes. Accordingly, dyeing fabric in some embodiments of the fabric dyeing apparatus 10 and/or methods of the present invention can significantly reduce the cost of dyeing fabric in conventional dyeing apparatus and utilizing conventional methods.

Whether a reactive dye or a direct dye, the dye is a colorant that adheres to a fabric substrate during application and exhibits some degree of permanence on the fabric. Dyes can be either natural or synthetic.

As described above, in some embodiments, a method of dyeing fabric can comprise utilizing a fiber reactive dye. FIG. 2 provides a chart identifying the additives, temperature, and cycle time in each of the chambers (11-25) of the fabric dyeing apparatus 10 for dyeing fabric in an embodiment of a reactive fabric dyeing process.

In some embodiments of a reactive dyeing method utilizing the 15-chamber fabric dyeing apparatus 10, the first eight chambers (11-18) can be utilized for creating the dye bath, adding an alkali, and holding the fabric load in exposure to the dye bath for a desired period of time, for example, for about 56 minutes, as described above with respect to the first eight chambers (11-18) in FIGS. 1 and 2. As shown in the embodiment in FIG. 1, the first through eighth chambers (11-18, respectively) through which the fabric load and dye bath are successively transferred can be referred to collectively as dye chambers 31.

In particular embodiments, an alkali can be added to raise the pH of the dye bath to within a range of about 11.0 to about 11.5. In some embodiments, one of the chambers (16-25) subsequent to the dye chambers 30 can comprises an acid rinse. An acid, such as acetic acid, can be added to neutralize the alkaline environment in the fabric dyeing process created by the previously added alkali. Preferably, a sufficient amount and concentration of acid can be added to bring the surface of the fabric to a pH of about 7.0. One of the chambers subsequent to the chamber comprising the acid rinse can comprise an after scour rinse for the purpose of removing excess dye from the fabric after the dye has been chemically reacted with the fabric. And, one of the chambers subsequent to the chamber comprising the after scour rinse comprises a softener rinse.

For example, in an embodiment of a reactive fabric dyeing process, as illustrated in FIG. 2, the method can include adding the fabric load to a dye bath in a first chamber 11 comprising water, salt, lubricant, and wetting agent. The salt can be any salt useable in commercial fabric dyeing processes, for example, sodium chloride (NaCl) or sodium sulfate (Na₂SO₄). The lubricant can be an oil or oil emulsion that decreases rubbing of the surfaces of the fabric or fabric products against each other and thus avoid pilling of the fabric during processing. The wetting agent, or wetter, can be a surfactant that is effective in promoting wetting of a textile by lowering the surface tension of a liquid, such as water, so as to increase its spreading and penetrating properties. Use of a wetting agent can facilitate absorption of the dye by the fabric.

The fabric load and dye bath are transferred from the first chamber 11 to a second chamber 12 and a reactive dye is added. The fabric load and dye bath are next transferred to a third chamber 13 and an alkali is added. The fabric load and dye bath are then successively transferred to a fourth through eighth chambers 14-18, respectively, and heated to within the same temperature range in each of the fourth through eighth chambers 14-18, respectively. From the eighth chamber 18, the fabric load is transferred to a subsequent chamber including a water and acid rinse. Finally, the fabric load is transferred to a water and after scour rinse in a chamber subsequent to the chamber having the water and acid rinse.

As shown in the particular embodiment of a fiber reactive dyeing process in FIG. 2, a fabric load can be added to a dye bath in the first chamber 11 comprising water, salt, lubricant, and wetting agent, and heated to between about 90 and about 110 degrees F., preferably about 100 degrees F., for about eight minutes. The fabric load and dye bath can be transferred from the first chamber 11 to the second chamber 12, a dye added to the bath, and heated to between about 90 and about 110 degrees F., preferably about 100 degrees F., for about eight minutes. The fabric load and dye bath can be transferred from the second chamber 12 to the third chamber 13, an alkali added to raise the pH of the dye bath to within a range of about 11.0 to about 11.5, and heated to between about 90 and about 110 degrees F., preferably about 100 degrees F., for about eight minutes. The fabric load and dye bath can be transferred from the third chamber 13 to the fourth chamber 14, and heated to between about 120 and about 180 degrees F., preferably between about 135 and about 145 degrees F., for about eight minutes. The fabric load and dye bath can be transferred from the fourth chamber 14 to the fifth chamber 15, and heated to between about 120 and about 180 degrees F., preferably between about 135 and about 145 degrees F., for about eight minutes. The fabric load and dye bath can be transferred from the fifth chamber 15 to the sixth chamber 16, and heated to between about 120 and about 180 degrees F., preferably between about 135 and about 145 degrees F., for about eight minutes. The fabric load and dye bath can be transferred from the sixth chamber 16 to the seventh chamber 17, and heated to between about 120 and about 180 degrees F., preferably between about 135 and about 145 degrees F., for about eight minutes. The fabric load and dye bath can be transferred from the seventh chamber 17 to the eighth chamber 18, heated to between about 120 and about 180 degrees F., preferably between about 135 and about 145 degrees F., for about eight minutes, and the dye bath drained.

The fabric load can then be transferred from the eighth chamber 18 to the ninth chamber 19 into a water rinse having a temperature in the range of about 60 degrees F. to about 100 degrees F. for about eight minutes, and the water rinse drained. The fabric load can then be transferred from the ninth chamber 19 to the tenth chamber 20 into a water and acid rinse to bring the surface of the fabric to a pH of about 7.0, heated to between about 130 degrees F. and about 150 degrees F., preferably about 140 degrees F., for about eight minutes, and the water and acid rinse drained. The fabric load can then be transferred from the tenth chamber 20 to the eleventh chamber 21 into a water rinse, heated to between about 130 degrees F. and about 150 degrees F., preferably about 140 degrees F., for about eight minutes, and the water rinse drained. The fabric load can then be transferred from the eleventh chamber 21 to the twelfth chamber 22 into a water and after scour rinse, heated to between about 180 degrees F. about 200 degrees F., preferably about 190 degrees F., for about eight minutes, and the water and after scour rinse drained. The fabric load can then be transferred from the twelfth chamber 22 to the thirteenth chamber 23 into a water rinse, heating to between about 130 degrees F. and about 150 degrees F., preferably about 140 degrees F., for about eight minutes, and the water rinse drained. The fabric load can then be transferred from the thirteenth chamber 23 to the fourteenth chamber 24 into a water rinse, heated to between about 130 degrees F. and about 150 degrees F., preferably about 140 degrees F., for about eight minutes, and the water rinse drained. The fabric load can then be transferred from the fourteenth chamber 24 to the fifteenth chamber 25 into a water and softener rinse, heated to between about 110 degrees F. and about 120 degrees F. for about eight minutes, and the water rinse drained. Accordingly, the method of dyeing fabric or fabric product illustrated in FIG. 2 can be accomplished in the 15-chamber fabric dyeing apparatus 10 illustrated in FIG. 1, to provide a load of dyed fabric or fabric product in a cost-effective manner. In such a method, the fabric load can be processed through the fabric dyeing apparatus 10 in about two hours.

Examples of the additives to water in such a fiber reactive dyeing process are provided in Table 1 below:

TABLE 1

| Additive | Commercial Example | Amount |
|---|---|---|
| Salt | Sodium Sulfate or Sodium | 100 grams/liter of water |
| | Chloride | |
| Lubricant | Surlube CAR | 1.00% |
| Wetting Agent | Surchem Jet | 1.00% |
| Dye | Permabril Orange BF-2R | 0.44% |
| Dye | Permabril Red BF-RX | 0.11% |
| Dye | Permabril Black DTM | 4.62% |
| Alkali | Surchem E.F.A. Plus | 4.00% (liquid) |
| Acid | Acetic Acid | 1.00% |
| Softener | Sursoft HB-NA | 1.50% |

These additives are commercially available from Surry Chemicals, Inc., in Mount Airy, N.C. Surlube CAR is both a fiber-to-fiber and a fiber-to-metal lubricant. Surchem Jet is an anionic/non-ionic wetter. The amount of each dye to be added depends on the amount of cotton in the fabric being dyed. The Permabril dyes are vinyl sulfone class dyes; the dye baths including this class of dyes should be heated to the temperature ranges shown in FIG. 2. If other classes of dyes are utilized, the temperatures to which the dye baths are heated can vary. Sursoft HB-NA is a cationic hydrophilic softener.

As described above, in some embodiments, a method of dyeing fabric can comprise utilizing a direct fiber dye. FIG. 3 provides a chart identifying the additives, temperature, and cycle time in each of the chambers of the fabric dyeing apparatus 10 shown in FIG. 1, for dyeing fabric in an embodiment of a direct fabric dyeing process of the present invention.

In some embodiments of a direct dyeing method utilizing the 15-chamber fabric dyeing apparatus 10, the first six chambers (11-16) can be utilized for creating the dye bath, adding a salt, and holding the fabric load in exposure to the dye bath for a desired period of time, for example, for about 48 minutes, as described above with respect to the first six chambers (11-16) in FIGS. 1 and 3. As shown in the embodiment in FIG. 1, the first through sixth chambers (11-16, respectively) through which the fabric load and dye bath are successively transferred can be referred to collectively as dye chambers 30.

As shown in the embodiment of a direct dyeing process in FIG. 3, a fabric load can be added to a dye bath in the first chamber 11 comprising water, dye, lubricant, and wetting agent. The fabric load and dye bath can be transferred to the second chamber 12 and a salt added. The fabric load and dye bath can then be successively transferred through the third through sixth chambers 13-16, respectively, and heated to within a first temperature range in each of the third through sixth chambers 13-16, respectively. The fabric load can then be transferred to each of the seventh through tenth chambers 17-20, respectively, each of the seventh through tenth chambers 17-20, respectively, having a separate water and salt rinse in a second temperature range lower than the first temperature range. The fabric load can then be transferred into the eleventh chamber 21 comprising a water bath having a cellulosic fixing agent. The fabric load and water bath can then be transferred to each of the twelfth through fourteenth chambers 22-24, respectively, and heated to within a third temperature range between the first and second temperature ranges in each of the twelfth through fourteenth chambers 22-24, respectively. And, then the fabric load can be transferred into the fifteenth chamber 25 into a water and softener rinse.

In a particular embodiment of such a direct dyeing process, the fabric load can be added to a dye bath in the first chamber 11 comprising water, dye, lubricant, and wetting agent, and held a temperature between about 60 degrees F. and about 100 degrees F., preferably about 100 degrees F., for about eight minutes. The fabric load and dye bath can then be transferred from the first chamber 11 to the second chamber 12, salt added, and the temperature of the bath controlled to between about 60 degrees F. and about 100 degrees F., preferably about 140 degrees F., for about eight minutes. The fabric load and dye bath can then be transferred from the second chamber 12 to the third chamber 13, then to the fourth chamber 14, and then to the fifth chamber 15, and the bath heated in each of the third, fourth, and fifth chambers 13, 14, 15, respectively, to between about 200 degrees F. and about 210 degrees F. for about eight minutes. The fabric load and dye bath can then be transferred from the fifth chamber 15 to the sixth chamber 16, heated to between about 200 degrees F. and about 210 degrees F. for about eight minutes, and the dye bath drained.

The fabric load can then be transferred from the sixth chamber 16 to the seventh chamber 17 into a water and salt rinse having a temperature between about 60 degrees F. and about 100 degrees F. for about eight minutes, and the rinse drained. The fabric load can then be transferred from the seventh chamber 17 to the eighth chamber 18 into a water and salt rinse having a temperature between about 60 degrees F. and about 100 degrees F. for about eight minutes, and the rinse drained. The fabric load can then be transferred from the eighth chamber 18 to the ninth chamber 19 into a water and salt rinse having a temperature between about 60 degrees F. and about 100 degrees F. for about eight minutes, and the rinse drained. The fabric load can then be transferred from the ninth chamber 19 to the tenth chamber 20 into a water and salt rinse having a temperature between about 60 degrees F. and about 100 degrees F. for about eight minutes, and the rinse drained. The fabric load can then be transferred from the tenth chamber 20 to the eleventh chamber 21 comprising a water bath having a cellulosic fixing agent and a temperature between about 60 degrees F. and about 100 degrees F. for about eight minutes. The fabric load and water bath can then be transferred from the eleventh chamber 21 to the twelfth chamber 22 and heated to between about 120 degrees F. and about 180 degrees F. for about eight minutes. The fabric load and water bath can then be transferred from the twelfth chamber 22 to the thirteenth chamber 23 and heated to between about 120 degrees F. and about 180 degrees F. for about eight minutes. The fabric load and water bath can then be transferred from the thirteenth chamber 23 to the fourteenth chamber 24, heated to between about 120 degrees F. and about 180 degrees F. for about eight minutes, and the water bath drained. The fabric load can then be transferred from the fourteenth chamber 24 to the fifteenth chamber 25 into a water and a softener rinse having a temperature between about 110 degrees F. and about 120 degrees F. for about eight minutes, and the rinse drained. Accordingly, the method of dyeing fabric or fabric product illustrated in FIG. 3 can be accomplished in the 15-chamber fabric dyeing apparatus 10 illustrated in FIG. 1, to provide a load of dyed fabric or fabric product in a cost-effective manner. In such a method, the fabric load can be processed through the fabric dyeing apparatus 10 in about two hours.

Examples of the additives to water in such a fiber direct dyeing process are provided in Table 2 below:

TABLE 2

| Additive | Commercial Example | Amount |
|---|---|---|
| Dye | Permalite Black SL | 2.59% |
| Lubricant | Surlube CAR | 1.00% |
| Wetting Agent | Surchem Jet | 1.00% |
| Salt in dye bath | Sodium Sulfate or Sodium | 40% based on weight |
| | Chloride | of fabric |
| Salt in rinses | Sodium Sulfate or Sodium | 3% |
| | Chloride | |
| Fixing Agent | Stanfix HB | 4% |
| Softener | Sursoft HB-NA | 1.50% |

These additives are commercially available from Surry Chemicals, Inc., in Mount Airy, N.C. The amount of dye to be added depends on the amount of cotton in the fabric being dyed. Surlube CAR is both a fiber-to-fiber and a fiber-to-metal lubricant. Surchem Jet is an anionic/non-ionic wetter. Stanfix HB is a cationic cellulosic fixing agent. Sursoft HB-NA Jet is a cationic hydrophilic softener.

Some embodiments of the fabric dyeing apparatus 10 and/or method according to the present invention can provide advantages over conventional approaches to fabric dyeing. For example, compared to a conventional fabric dyeing process, some embodiments of the present invention can operate using at least a decreased amount of water, and possibly a decreased amount of chemicals, in the dye bath mixture, thereby providing a cost savings.

Another advantage is that some embodiments of the present invention can provide a substantial reduction in processing time, thereby allowing a cost savings. For example, some embodiments can provide for fully processing a load of fabric or fabric product in about two hours, or about one-third of the time required by conventional reactive dye batch fabric dyeing processes.

Another advantage is that some embodiments of the present invention can provide a cost savings by reusing the same heated dye bath in the first set of dye chambers 30, for example, the first six or eight chambers. As a result of the first set of dye chambers 30, 31 being heated to the same temperature, and the load of fabric or fabric product and the same dye bath being transferred through the first set of dye chambers 30, 31, the amount of time and energy required to heat the subsequent chambers in the first set of dye chambers 30, 31 to the desired temperature is reduced.

Another advantage is that, due to a decreased amount of water and chemical additives in the dye bath mixture compared to some conventional dyeing processes, some embodiments of the present invention can cause less effluent discharge of water and chemicals and thus provide protection to the environment. In addition, reusing the dye bath in certain chambers (for example, chambers 11-16 or 11-18) has the advantages of reducing the amount of water required to provide a fresh bath in each of the chambers (11-25) and of correspondingly reducing the amount of wastewater that must be treated before being discarded into the environment.

Another advantage is that transferring the dye bath directly from one chamber to another in certain embodiments of the present invention avoids steps in conventional dye bath recovery and reuse processes, thereby saving the costs involved with those steps. For example, transferring the dye bath directly from one chamber to another can avoid steps such as removing the dye bath from the fabric load, treating the bath, analyzing the bath for levels of dye and associated chemicals, replenishing the dye and associated chemicals to desired levels, and/or returning the refreshed bath to the chamber.

Embodiments of the fabric dyeing apparatus and/or method according to the present invention can be utilized in a variety of applications. For example, some embodiments of the apparatus and/or method can be utilized to dye socks. In other embodiments, the fabric dyeing apparatus and/or method can be utilized to dye fabric prior to being constructed into a garment or other fabric product or in fabric products other than socks.

Features of a fabric dyeing apparatus and/or method of the present invention may be accomplished singularly, or in combination, in one or more of the embodiments of the present invention. Although particular embodiments have been described, it should be recognized that these embodiments are merely illustrative of the principles of the present invention. Those of ordinary skill in the art will appreciate that a fabric dyeing apparatus and/or method of the present invention may be constructed and implemented in other ways and embodiments. Accordingly, the description herein should not be read as limiting the present invention, as other embodiments also fall within the scope of the present invention.

What is claimed is:

1. A fabric dyeing apparatus, comprising:
a tunnel comprising a plurality of chambers through which a load of fabric is successively transferred;
a first set of the plurality of chambers comprising a consecutive series of dye chambers through which the fabric load and a single dye bath are successively transferred, the dye bath heated to about the same temperature in each of the dye chambers, and in which the fabric load is exposed to the dye bath for about 35 minutes to about 60 minutes;
a first chamber in the series of dye chambers and selected chambers subsequent to the dye chambers adapted to receive a fresh water bath; and
a last chamber in the series of dye chambers and selected chambers subsequent to the dye chambers adapted to drain the bath in those chambers.

2. The apparatus of claim 1, further comprising a weight ratio of dye bath mixture-to-fabric of about 5:1.

3. The apparatus of claim 1, wherein the dye bath comprises a fiber reactive dye or a direct fiber dye.

4. The apparatus of claim 1,
wherein one of the chambers subsequent to the dye chambers comprises an acid rinse;
wherein one of the chambers subsequent to the chamber comprising the acid rinse comprises an after scour rinse; and
wherein one of the chambers subsequent to the chamber comprising the after scour rinse comprises a softener rinse.

5. The apparatus of claim 1, wherein the tunnel further comprises a modified bleaching tunnel.

6. The apparatus of claim 1, wherein the tunnel further comprises 15 chambers.

7. The apparatus of claim 1,
wherein the tunnel further comprises a horizontally disposed drum structure, the plurality of chambers disposed along a central axis between an inlet end into which the fabric load can be inserted and an outlet end through which the fabric load can be discharged, and
wherein each of the plurality of chambers is movable at least partially about the axis of the drum structure.

8. The apparatus of claim 1, wherein the tunnel is adapted to bleach the fabric load in one cycle through the plurality of chambers and dye the fabric load in another cycle through the plurality of chambers.

9. The apparatus of claim 1, wherein the fabric comprises cotton or a cotton blend.

10. A method for dyeing fabric, comprising:
modifying a fabric bleaching tunnel comprising a plurality of chambers to receive a dye bath in a first set of selected chambers and to drain the bath in a second set of selected chambers such that a load of fabric can be successively transferred through the plurality of chambers, wherein the bleaching tunnel is capable of dyeing fabric.

11. The method of claim 10, further comprising transferring the fabric load into the dye bath at a weight ratio of the dye bath-to-fabric of about a 5:1.

12. The method of claim 10, further comprising bleaching the fabric load in one cycle through the plurality of chambers and dyeing the fabric load in another cycle through the plurality of chambers.

13. The method of claim 10, further comprising:
adding the fabric load to a dye bath in a first chamber comprising water, salt, lubricant, and wetting agent;
transferring the fabric load and dye bath to a second chamber and adding a dye;
transferring the fabric load and dye bath to a third chamber and adding an alkali;
successively transferring the fabric load and dye bath to a fourth through eighth chambers and heating to within the same temperature range in each of the fourth through eighth chambers;
transferring the fabric load to a water and acid rinse in a chamber subsequent to the eighth chamber; and
transferring the fabric load to a water and after scour rinse in a chamber subsequent to the chamber having the water and acid rinse.

14. The method of claim 13, wherein the dye comprises a fiber reactive dye.

15. The method of claim 10, further comprising:
adding the fabric load to a dye bath in a first chamber comprising water, salt, lubricant, and wetting agent, and heating to between about 90 and about 110 degrees F.;
transferring the fabric load and dye bath to a second chamber, adding a dye, and heating to between about 90 and about 110 degrees F.;
transferring the fabric load and dye bath to a third chamber, adding an alkali to raise the pH of the dye bath to within a range of about 11.0 to about 11.5, and heating to between about 90 and about 110 degrees F.;
transferring the fabric load and dye bath to a fourth chamber, and heating to between about 120 and about 180 degrees F.;
transferring the fabric load and dye bath to a fifth chamber, and heating to between about 120 and about 180 degrees F.;
transferring the fabric load and dye bath to a sixth chamber, and heating to between about 120 and about 180 degrees F.;
transferring the fabric load and dye bath to a seventh chamber, and heating to between about 120 and about 180 degrees F.;
transferring the fabric load and dye bath to an eighth chamber, heating to between about 120 and about 180 degrees F., and draining the dye bath;
transferring the fabric load to a ninth chamber into a water rinse having a temperature in the range of about 60 degrees F. to about 100 degrees F., and draining the water rinse;
transferring the fabric load to a tenth chamber into a water and acid rinse to bring the surface of the fabric to a pH of about 7.0, heating to between about 130 degrees F. and about 150 degrees F., and draining the water and acid rinse;
transferring the fabric load to an eleventh chamber into a water rinse, heating to between about 130 degrees F. and about 150 degrees F., and draining the water and acid rinse;
transferring the fabric load to a twelfth chamber into a water and after scour rinse, heating to between about 180 degrees F. about 200 degrees F., and draining the water and after scour rinse;
transferring the fabric load to a thirteenth chamber into a water rinse, heating to between about 130 degrees F. and about 150 degrees F., and draining the water rinse;
transferring the fabric load to a fourteenth chamber into a water rinse, heating to between about 130 degrees F. and about 150 degrees F., and draining the water rinse; and
transferring the fabric load to a fifteenth chamber into a water and softener rinse, heating to between about 110 degrees F. and about 120 degrees F., and draining the water rinse.

16. The method of claim 15, further comprising holding the fabric load in each chamber for about eight minutes, wherein the fabric load is processed through the apparatus in about two hours.

17. The method of claim 10, further comprising:
adding the fabric load to a dye bath in a first chamber comprising water, dye, lubricant, and wetting agent;
transferring the fabric load and dye bath to a second chamber and adding salt;
successively transferring the fabric load and dye bath to a third through sixth chambers and heating to within a first temperature range in each of the third through sixth chambers;
successively transferring the fabric load to each of a seventh through tenth chambers, each of the seventh through tenth chambers having a separate water and salt rinse in a second temperature range lower than the first temperature range;
transferring the fabric load into an eleventh chamber comprising a water bath having a cellulosic fixing agent;
successively transferring the fabric load and water bath to each of a twelfth through fourteenth chambers and heating to within a third temperature range between the first and second temperature ranges in each of the twelfth through fourteenth chambers; and
transferring the fabric load into a fifteenth chamber into a water and softener rinse.

18. The method of claim 17, wherein the dye comprises a direct fiber dye.

19. The method of claim 10, further comprising:
adding the fabric load to a dye bath in a first chamber comprising water, dye, lubricant, and wetting agent, and having a temperature between about 60 degrees F. and about 100 degrees F.;
transferring the fabric load and dye bath to a second chamber, adding salt, and controlling the temperature of the bath to between about 60 degrees F. and about 100 degrees F.;
transferring the fabric load and dye bath to a third chamber, then to a fourth chamber, and then to a fifth chamber, and heating the bath in each chamber to between about 200 degrees F. and about 210 degrees F.;
transferring the fabric load and dye bath to a sixth chamber, heating to between about 200 degrees F. and about 210 degrees F., and draining the dye bath;
transferring the fabric load to a seventh chamber into a water and salt rinse having a temperature between about 60 degrees F. and about 100 degrees F., and draining the rinse;
transferring the fabric load to a eighth chamber into a water and salt rinse having a temperature between about 60 degrees F. and about 100 degrees F., and draining the rinse;
transferring the fabric load to a ninth chamber into a water and salt rinse having a temperature between about 60 degrees F. and about 100 degrees F., and draining the rinse;
transferring the fabric load to a tenth chamber into a water and salt rinse having a temperature between about 60 degrees F. and about 100 degrees F., and draining the rinse;
transferring the fabric load to an eleventh chamber comprising a water bath having a cellulosic fixing agent and a temperature between about 60 degrees F. and about 100 degrees F.;
transferring the fabric load and water bath to a twelfth chamber and heating to between about 120 degrees F. and about 180 degrees F.;
transferring the fabric load and water bath to a thirteenth chamber and heating to between about 120 degrees F. and about 180 degrees F.;
transferring the fabric load and water bath to a fourteenth chamber, heating to between about 120 degrees F. and about 180 degrees F., and draining the water bath; and
transferring the fabric load to a fifteenth chamber into a water and a softener rinse having a temperature between about 110 degrees F. and about 120 degrees F., and draining the rinse.

20. The method of claim 19, further comprising holding the fabric load in each chamber for about eight minutes, wherein the fabric load is processed through the apparatus in about two hours.
